(19) United States
(12) Patent Application Publication
(10) Pub. No.: US 2008/0195512 A1
(43) Pub. Date: Aug. 14, 2008

(54) System and method for administering consecutive and concurrent leaves

(75) Inventors: David S. Klebanoff, Toronto (CA); Brian A. Bowman, Toronto (CA); Matthew L. Lucid, Waterloo (CA); Aleksandar Susnjar, Markham (CA)

Correspondence Address: BERESKIN AND PARR, 40 KING STREET WEST, BOX 401, TORONTO, ON, M5H 3Y2, omitted

(73) Assignee: Workbrain Inc., Toronto (CA)

(21) Appl. No.: 11/703,637

(22) Filed: Feb. 8, 2007

(51) Int. Cl. G06Q 10/00

(52) U.S. Cl. 705/32

(57) ABSTRACT

A system and method for administering leave policies to employee absences. All absences that occurred in a particular time period are identified. A leave policy is determined for each identified absence. Each leave policy specifies at least one leave sequence that has at least one leave. The leave has an associated balance. A position in each leave sequence is determined. The leave balances are updated according to the position in each leave sequence and the length of the absence.

### FIELD

The embodiments described herein relate to systems and methods for administering concurrent leaves.

### BACKGROUND

In today's society managing employee absences can be a complicated task for a variety of reasons. One complicating factor is that, as time passes, organizations tend to grow in terms of their size and the number of people they employ. Thus, a typical organization may have to manage a great number of people. Complicating things further, as an organization grows the reporting structure within an organization may become more complicated. There may be a greater number of people that are responsible for overseeing employees. With a greater number of people managing employees and their absences, a rise in inconsistencies in how absenteeism is dealt with may occur.

Another complicating factor is, as time passes, there are a greater number of rules that may affect how an employee may take a leave of absence. For example, federal statutes, state statutes, corporate policies, and collective bargaining agreements may all affect the rules by which an employee may take a leave of absence from work. As the rules become more numerous and complicated, it becomes increasingly difficult to apply them properly. As a result, the people in charge of administering leaves to employee absences may choose to apply the simplest rules or the rules with which they are most familiar. This in turn may lead to employees not receiving the full extent of the benefits to which they are entitled. A 2006 Mercer Human Resources, Health, Productivity and Absence Management Programs Survey found that 76% of organizations experienced administrative and compliance issues with the U.S. federal Family and Medical Leave Act.

In addition, the employer may face an increase in costs from litigation or union grievances associated with employees that feel they have not been provided the benefits to which they are entitled. The cost of non-compliance to employers is significant and growing.

In addition, it is estimated that at any given time, between 3-10% of employees are absent each day (Source: Circadian Information, Shiftwork Practices 2005, citing the Bureau of Labor Statistics). For larger corporations, this is a significant number of employees, requiring considerable cost and effort and cost to manage and properly account for these absences. Without proper management of absences, employers may find themselves unnecessarily paying employees who are in fact absent, or paying additional overtime costs to cover for absent employees. The direct costs of scheduled and unscheduled absenteeism are estimated as 14% of payroll, while the indirect costs of absences can be double or triple that amount (Source: Mercer Human Resources, Health, Productivity and Absence Management Programs: 2006 Survey and Integrated Absence Management). In addition, there is growing evidence of abuse. A 2006 survey by CareerBuilder.com found that the incidence of healthy workers calling in sick had increased by 8% from 2004.

Complying with the applicable statues may be very difficult, complicated and costly. For example, FMLA leave is particularly noteworthy since the use of this type of leave by employees has been increasing with the growing workforce (Source: US Department of Labor FMLA Survey, 2000). In addition, the increasing age of the workforce will lead to an increase in health and medical related absences for the employees themselves, as well as additional absences related to the care of the employee's family members.

At an August 2001 meeting of the American Bar Association Labor and Employment Law Section, the management of employee absences, and particularly the FMLA leave was identified as one of the top employment issues facing in-house counsel. The following problems were specifically identified: (1) handling the interaction of state and federal FMLA statutes (including states such as California, Massachusetts, New Jersey) and (2) running FMLA leave, occupational injury leave, disability, and medical leave concurrently, including the need to notify the employee that such leaves will run concurrently.

Thus, there is a need for a system and method that is able to facilitate the accurate and legally compliant management of employee absenteeism.

### SUMMARY OF THE INVENTION

The embodiments described herein provide in one aspect, a method of administering leave policies to employee absences, the method comprising:
(a) determining at least one absence, having an absence length, for at least one employee in a time period;
(b) determining a leave policy for each absence, wherein the leave policy specifies at least one leave sequence having at least one leave, and wherein the leave has an associated leave balance;
(c) determining a position in each leave sequence; and,
(d) updating the at least one leave balance according to the position in the at least one leave sequence and the absence length.

The embodiments described herein provide in another aspect, a system for administering leave policies to employee absences, the system comprising:
a memory for storing at least one leave policy, wherein the leave policy specifies at least one leave sequence having at least one leave, and wherein each leave has an associated leave balance; the memory being further adapted to store the at least one associated leave balance;
a processor coupled to the memory, said processor configured for:
   (I) determining at least one absence, having an absence length, for at least one employee in a time period;
   (II) determining a leave policy for each absence;
   (III) determining a position in each leave sequence; and,
   (IV) updating the at least one associated leave balance according to the position in the at least one leave sequence and the absence length.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a block diagram of an exemplary embodiment of a leave policy manager system;

FIG. 2 is a schematic diagram illustrating a graphical representation of a first exemplary leave policy;

FIG. 3 is a schematic diagram illustrating a graphical representation of a second exemplary leave policy;

FIG. 4 is a schematic diagram illustrating a graphical representation of a third exemplary leave policy;

FIG. 5 is a schematic diagram illustrating a graphical representation of a fourth exemplary leave policy;

FIG. 6 is a schematic diagram illustrating a graphical representation of a fifth exemplary leave policy;

FIG. 7 is a schematic diagram illustrating a graphical representation of a sixth exemplary leave policy;

FIG. 8 is a schematic diagram illustrating a graphical representation of a seventh exemplary leave policy;

FIG. 9 is a schematic diagram illustrating a graphical representation of a eighth exemplary leave policy;

FIG. 10 is a schematic diagram illustrating a graphical representation of a ninth exemplary leave policy;

FIG. 11 is a flowchart diagram of an example set of operational steps executed by the leave policy manager system of FIG. 1;

FIG. 12 is a flowchart diagram of an example set of operational steps executed by the leave policy manager system of FIG. 1 when determining leave details;

FIG. 12 is a flowchart diagram of an example set of operational steps executed by the leave policy manager system of FIG. 1 when determining the current position in a selected sequence;

FIGS. 14A and 14B are flowchart diagrams of an example set of operational steps executed by the leave policy manager system of FIG. 1 when determining the amount of balance to consume.

FIG. 15 is a flowchart diagram of an example set of operational steps executed by the leave policy manager system of FIG. 1 when determining the leave policy to apply.

FIG. 16 is a flowchart diagram of an example set of operational steps executed by the leave policy manager system of FIG. 1 when determining the notification and documentation that is to be sent.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

It will be appreciated that for simplicity and clarity of illustration, where considered appropriate, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), at least one input device, and at least one output device. For example and without limitation, the programmable computers may be a personal computer, laptop, personal data assistant, and cellular telephone. Program code is applied to input data to perform the functions described herein and generate output information. The output information is applied to one or more output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Described herein are various embodiments of a system and method for administering consecutive and concurrent leave policies. Specifically, the system and method administers leaves to employee absences based on one or more leave policies.

The term “absence”, as used herein, describes a continuous period of time during which an employee is away from work for a particular reason. An absence is continuous in the sense that work does not occur during the absence and the reason for the absence does not change during the absence. Thus, if the employee was at work between two periods of time away from work, then those two periods would each be a separate absence, even if they both have the same reason for being away. Similarly, even if an employee spends a continuous period of time away from work but the reason for the time away from work changes, then there may be at least two absences. More specifically, when a new reason for being away from work occurs, a new absence may begin.

The term “leave” as used herein refers to a set of rules that allows an employee to be absent from work. The rules may for example be, but are not limited to, legal rules dictated by statutes, policies of the employer, policies set according to conditions in union agreements, or they may be a combination of any of the above. Examples of various leaves may include but are not limited to: FMLA, State FML, Military Leave, Jury Duty Leave, Short Term Disability Leave, Long Term Disability Leave, Vacation Leave, Sick Leave, Pregnancy Disability Leave, Education Leave, Bereavement Leave, Personal Day Leave, and Sabbatical Leave.

The term “leave pattern” as used herein refers to a regularly repeating pattern of absences. A leave pattern is used in a situation in which an authorized person, such as a medical professional or case analyst, declares that an employee will be absent intermittently on a repeated basis. For example, a medical professional may declare that the employee needs to be absent for 2 hours per day, 3 days per week. In such a situation, the leave policy manager system will enforce these leave patterns by not permitting the use of a leave or leaves for reported absences that violate the pattern.

The term “corporate leave” will be used to describe a leave that is allowed by an employer. A corporate leave may be specified according to corporate policies or rules. Such rules or policies may be implemented in response to collective bargaining agreements. Examples of corporate leaves from the above list may include, but are not limited to, Personal Day Leave and Sabbatical Leave.

A leave may have several characteristics including but not limited to a mechanism of entitlement, a degree of pay, a waiting period, a maximum amount that can be taken, and a disciplinary status. However, it should be noted that not every leave needs to have all the aforementioned characteristics and each leave may have other characteristics as well.

The mechanism of entitlement determines the amount of leave that an employee is entitled to at a particular point in time. An employee may become entitled to a particular amount of a particular leave through one or more means. For example, an entitlement to a leave may be based on an employee's length of employment. Alternatively, an entitlement may be granted by a statute such as the Family Medical Leave Act (hereinafter “FMLA”). In addition, an entitlement to a leave may accrue incrementally, such as for example, by monthly accrual. The amount of time that an employee is entitled to with respect to a particular leave may be represented as a balance.

The degree of pay determines the amount, if any, that is paid to the employee during the absence. For example, some leaves, such as those taken under the FMLA are unpaid. In contrast, other leaves, such as sick leave, may be paid according to a certain formula.

In addition, certain leaves may have waiting periods associated with them. The waiting period begins at the same time as the absence and must be consumed prior to the leave taking effect. In addition, some leaves may specify a maximum amount that may be taken in a given time period. For example, an employee may only be allowed to apply a certain portion of a leave in a single absence. As a more specific example, an employee may not be allowed to take more than 5 days of vacation at a time. In addition, an employee may be disciplined for taking certain leaves or for taking too much of a certain type of leave.

A particular absence may have several leaves associated with it. In particular, an absence may be associated with two or more consecutive leaves or two or more concurrent leaves or with a combination of consecutive and concurrent leaves. The term concurrent leaves will be used to refer to leaves that either occur or may occur at the same time. For example, an employee that has taken a FMLA leave may also choose to take a vacation leave for the beginning portion of the absence. This may allow the employee to be paid when he or she would not otherwise be paid since FMLA is an unpaid leave.

The term “consecutive leaves” will be used to refer to leaves that occur in sequence and do not overlap one another in terms of the time at which they take effect. Thus, consecutive leaves may have an implied or explicit dependency or priority relationship. For example, the first leave must be processed before the second leave begins. In addition, a consecutive relationship may require that multiple leaves finish before a given leave can start. This sort of relationship may be referred to as a “fan in” relationship.

In some embodiments, the term “consecutive leaves” is used to describe two or more leaves that have a priority relationship as opposed to a strict sequential relationship. In such a priority relationship, the higher priority leave may run first until its balance is exhausted. At this point, the lower priority leave may begin to run, assuming it has sufficient balance. For a variety of reasons, it is possible that additional balance will accrue to the higher priority leave after the second leave has started running. At this point, the lower priority leave will stop running and the higher priority leave will run again. This back and forth between the two leaves may continue as long as conditions allow for it. In addition, such a priority relationship is not limited to two leaves but can also apply to a number of leaves that is greater than two.

The term “discretionary leave” will be used to refer to a leave that may be taken at the discretion of the employee. Thus, the employee may be able to choose when to take the leave and the amount of leave to be taken. In addition, the employee may be able to determine whether or not to take the leave in the first place. An example of a discretionary leave is a vacation.

The term “leave policy” as used herein may be defined as a description of a structure and a manner of processing the leaves that can apply to an absence, for a specific absence reason. A leave policy comprises a set of leaves that may be applied to an absence. Thus, a leave policy may specify one or more leaves, their priority with respect to one another, concurrency, dependencies, wait times, maximums as well as other characteristics. The following is an example of a leave policy for an absence that may be taken with respect to the “Care of Self” leave under the FMLA:

Vacation and Sick (Discretionary leaves)

Short Term Disability (STD), with a 5-day waiting period preceding it

FMLA

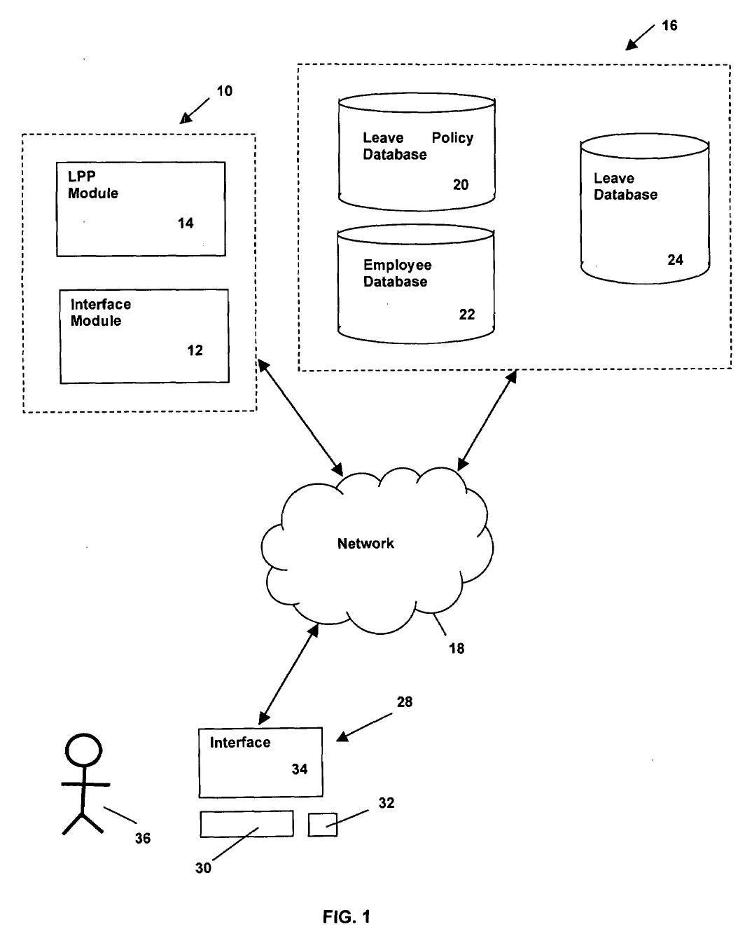

Reference is now made to FIG. 1, which illustrates various embodiments of a leave policy manager system 10. Leave policy manager system 10 includes an interface module 12 and a Leave Policy Processing (LPP) module 14.

Leave policy manager system 10 may be coupled to leave database server 16 through a network 18, which may be for example, but is not limited to, a wide area network, a local area network, an intranet, or the Internet. Leave database server 16 comprises a leave policy database 20, employee database 22, and leave database 24. In some embodiments, databases 20, 22, and 24 need not be located on a single server but may be distributed over various systems or devices. In various other embodiments, leave database server 16 and leave policy manager system 10 may reside on a single system and need not communicate through a network.

As discussed in more detail above, it should be understood that leave policy manager system 10 may be implemented in hardware or software or a combination of both. Specifically, the modules of leave policy manager system 10 are preferably implemented in computer programs executing on programmable computers each comprising at least one processor, a data storage system and at least one input and at least one output device. Without limitation, the programmable computers may be a mainframe computer, server, personal computer, laptop, personal data assistant or cellular telephone. In some embodiments, leave policy manager system 10 is implemented in software and installed on the hard drive of user workstation 28 and on leave database server 16, such that user workstation 32 interoperates with leave database server 16 in a client-server configuration. In other embodiments, leave policy manager system 10 may run from a single dedicated workstation. In yet other embodiments, the leave policy manager system 10 can be configured to run remotely on one or more user workstations 28 while communication with leave database server 16 occurs via a wide area network (WAN), such as through the Internet. In yet other embodiments, leave policy manager system 10 may run on one or more dedicated servers. In such embodiments, leave policy manager system 10 may interoperate with leave database server 16 and user workstation 28 as required.

Interface module 12 provides interfacing capabilities between leave policy manager system 10, leave database server 16, and user workstation 28. LPP module 14 processes and administers various leave policies according to the absences reported.

Leave policy database 20 stores various leave policies that may be applicable to a particular company. These leave policies may be periodically updated based on changes to laws, corporate policies or labor union agreements. Employee database 22 stores employee specific information, which may include, but is not limited to, an employee's schedule, disciplinary status, eligibility for various leaves, the balance carried by the employee for various leaves, and specific policies that are applicable to the employee. Leave database 24 stores information pertaining to each type of leave that is part of the leave policies used by the particular company or corporation. The leave information may be updated from time to time in order to reflect changes to laws, corporate policies or labor union agreements.

Continuing to refer to FIG. 1, user workstation 28 may include a keyboard 30 and a user pointing device 32 (e.g. mouse). It should be understood that user workstation 34 may be implemented by any wired or wireless personal computing device with input and display means (e.g. conventional personal computer, laptop computing device, personal digital assistant (PDA), wireless communication device, etc.). User workstation 28 is operatively connected to an interface 34. In various exemplary embodiments, user workstation 28 interoperates with leave policy manager system 10 in a client-server configuration. In some embodiments, user workstation 28 runs an application, such as web browser, that interoperates with leave policy manager system 10, through a website. Such interoperation may occur through a network such as the Internet or an intranet.

User 36 may use user workstation 28 for a variety of reasons including but not limited to reporting absences, updating leave policies, updating employee information and schedules. A variety of different users 36 may exist. For example, the people who may be a user 36 may include, but are not limited to, employees, supervisors, administrative staff, and case analysts. People employed by a third party to maintain a company's leave policy or absence program may also constitute users 36.

Each user 36 may have a different level of access. Thus, for example, certain administrative staff may be given sufficient access to alter leave policies that are stored in leave policy database 20 while most employees would likely not be given this level of access. Similarly, a case analyst or supervisor may have sufficient access to the employee database to set leave approvals for specific employees for various types of leaves.

In various embodiments leave policy manager system 10 is operable to record and track employee absences. In addition, leave policy manager system 10 is capable of determining appropriate policies to apply to an absence based on various factors such as employee eligibility or whether their leave has been approved. Based on these determinations, leave policy manager system 10 applies various leave policies to employee absences and updates appropriate information such as the employee's balance with respect to certain leaves. Similarly, in various embodiments, leave policy manager system 10 is operable to determine if an employee's absence is disciplinable or not. Other examples of information that may be determined or updated include but are not limited to the employee's pay adjustments, time sheets and schedules of other employees. Thus, for example, if a leave of a certain employee is entered into leave policy manager system 10, then leave policy manager system 10 may automatically adjust other schedules of employees in order to compensate for the absent employee.

In some embodiments, leave policy manager system 10 is capable of initiating disciplinary action by for example, but not limited to, sending notices to appropriate supervisors, administrative staff or case analysts. In addition, in various embodiments, leave policy manager system 10 automatically notifies appropriate personnel of the employee absence. This may for example be done through an email or text message. Moreover, in some embodiments, leave policy manager system 10 automatically generates letters to employees or work groups regarding the absence and/or the leaves that are in effect.

Furthermore, in some embodiments, leave policy manager system 10 is operable to communicate with various other systems through network 18. For example, leave policy manager system 10 may communicate with systems in other departments of the company such as payroll and human resources. In some embodiments, leave policy manager system 10 communicates with such systems in order to consistently track such things as the attendance of employees as well as the specific times at which employees are absent from work. In addition, leave policy manager system 10 may communicate with systems outside of the company such as long or short term disability benefits providers or workers compensation providers.

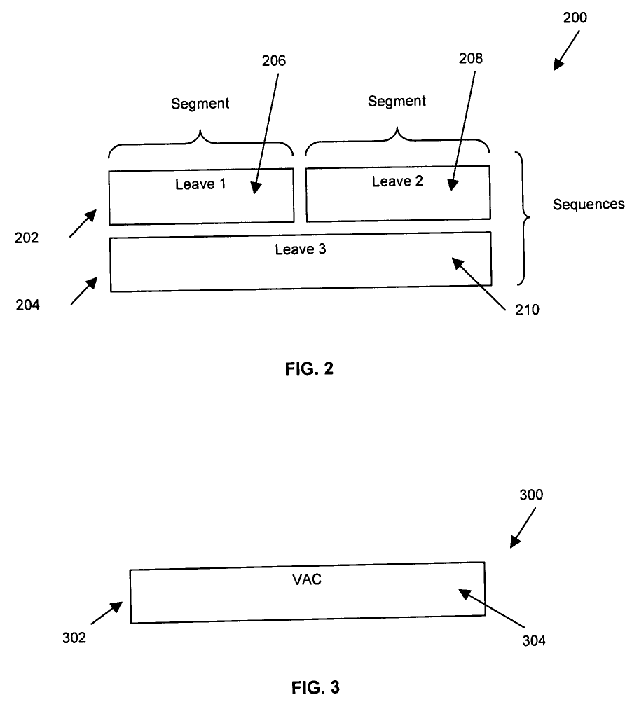

Reference is now made to FIG. 2, which is a schematic diagram illustrating a graphical representation of a leave policy 200. Leave policy 200 comprises two sequences 202 and 204. Sequence 202 comprises two segments 206 and 208. Similarly, sequence 204 comprises a single segment 210. Thus, in this graphical representation, each row represents a single sequence and each segment is represented by a single rectangle.

Each segment consists of a single leave. Thus, as can be seen from FIG. 2, segment 206 consists of leave 1, segment 208 consists of leave 2, and segment 210 consists of leave 3.

In general, each sequence comprises one or more segments. If there is more than one segment in a sequence then these segments may represent consecutive leaves. Thus, in FIG. 2 leave 1 and leave 2 are consecutive leaves. In addition, the segments in a given sequence are ordered according to their priority. Thus, leave policy manager system 10 attempts to apply the leaves according to the their order. In the case of FIG. 2, leave policy manager system 10 would attempt to apply segment 206 (Leave 1) first. If it is unable to apply segment 206 (Leave 1) then it will attempt to apply segment 208 (Leave 2).

Although the concept of a sequence will continue to be used when describing various embodiments, it should be understood that this concept is not an essential one. In particular, it is possible to specify the relationship between segments, which are presented as being in a sequence, in various manners other than using the concept of a sequence. This will be discussed in greater detail below. Despite this, the concept of a sequence may be used by various embodiments in order to display leave policies to users 36 on interface 34. This may be for a variety of reasons including, but not limited to, that the use of a sequence provides a conceptually simple representation of leave policies that may otherwise appear very complicated. However, these same embodiments, may not utilize the concept of a sequence when actually implementing the leave policies, that is, when applying the leave policies to absences of an employee.

Each sequence runs concurrently with each of the other sequences. Thus in the case of FIG. 2, sequence 202 runs concurrently with sequence 204. This effectively means that segment 210 (Leave 3) runs concurrently with segment 206 (Leave 1) and then with segment 208 (Leave 2).

Each segment in a series is run until some dependency or constraint is satisfied. This may for example be, but is not limited to, a balance for the associated leave running out or a set maximum being reached. Each segment may optionally be set to have a maximum. This may be done for a variety of reasons including but not limited to complying with corporate or legal policy or to comply with a labor union agreement. For example, mandatory sick leave and vacation may be applied through the use of maximums.

Maximums can be determined and overridden by the system or a user 36 of the system. As described above, users 36 of the system may include any appropriate people including but not limited to case analysts and employees. Each different type of user may have a different level of access and ability to change parameters such as maximum values for segments. Thus, for example, an employee may be allowed sufficient access to change maximum values for discretionary leaves for him or herself. In contrast, a case analyst or supervisor may be granted full access to change maximum values for all leaves for all employees for which they are responsible. This may allow the case analyst to update leave policy information, which he or she may do on a periodic basis in order to, for example, keep the leave policy information in compliance with corporate or legal policy.

Referring again to FIG. 1, in some embodiments, initial leave policy information will be transferred into an employee's case. Once transferred, the policy information may be tailored by the case analyst, the employee or other authorized users as may be required. More specifically, this may be accomplished by a user 36 entering appropriate commands into user work station 28. As a result, one or more leave policies may be transferred from leave policy database 20 to employee database 22. Once the leave policies are in employee database 22, they may be tailored according to the needs of the specific employee. In addition, should any changes be made to any laws, corporate policies or union agreements, then any appropriate leave information in leave database 24 and leave policy database 20 may be updated. In some embodiments, if any changes are made to the leave information in leave database 24, then the appropriate information is updated in leave policy database 20 and employee database 22. Similarly, if any change is made to a leave policy in leave database 20 then the appropriate leave policies in employee database 22 may be updated as well.

In some embodiments, the updating of a leave policy may affect the application of the updated leave policy on an absence to which the leave policy has already been applied. In other words, if a leave policy has already been applied to an absence and the leave policy is subsequently updated, the effect of the application may be altered in order to reflect the updated version of the leave policy. The need to update the effect of an application of a leave policy that has already been applied to an absence but is subsequently altered may be determined by effective dates, approval process, and the law. The effective dates may refer to the date on which the approval occurred, the date on which the absence is to start or end, the date of changes of relevant policies and laws, as well as the date on which the actual update occurred.

In some embodiments, the approval of an application of a leave policy to an absence may cause that absence to be immune to any updates to the leave policy that result from corporate initiated leave policies. This may even be the case for absences that have not yet occurred. In addition, in some embodiments, although leave policy manager system 10 may prevent the application of updates resulting from corporate initiated changes, changes that occur as a result of changes to laws or statutes will be not be prevented from applying. In some embodiments, at least some updates to leave policies do not automatically affect absences for which the leave policies have already been approved and applied. Rather, in such embodiments, leave policy manager system 10 may allow an appropriate user 36 to review the update as well as the absence in order to determine the correct action. Similarly, in various embodiments, the effect of updates to leave policies for absences that have already occurred do not occur automatically but rather may allow an appropriate user 36 to review the update as well as the absence in order to determine the correct action.

The leave policy manager system 10 is operable to determine for any interval of time in an absence, the specific segment (or leave) that is in effect for each sequence in the leave policy. The leave policy manager system 10 is also operable to determine the paid status of the absence, the disciplinary status of the absence and the mechanism used to track the time (such as a time code) or other labor metric.

Reference is now made to FIG. 3, which illustrates a simple leave policy 300. Leave policy 300 consists of a single sequence 302, which in turn comprises a single segment 304. Segment 304 corresponds to a vacation leave. Thus, leave policy 300 could be used by leave policy manager system 10 to track a vacation leave of an employee. Under leave policy 300 the employee would be able to take vacation leave until the vacation balance is exhausted. After the vacation leave balance is exhausted the system records the absence as being bare.

The term “bare absence” will be used to refer to an absence to which no leave applies. In some embodiments, the employer may choose the manner in which a bare absence is dealt with. For example, an employer may determine that a bare absence is paid, or disciplined, both or neither. An employer is not limited to these actions and may determine that other treatment of bare absences is appropriate.

Leave policies can also be described using a notation called Leave Policy Notation Language (LPNL). In LPNL, leave policy 300 can be represented as:

1: VAC

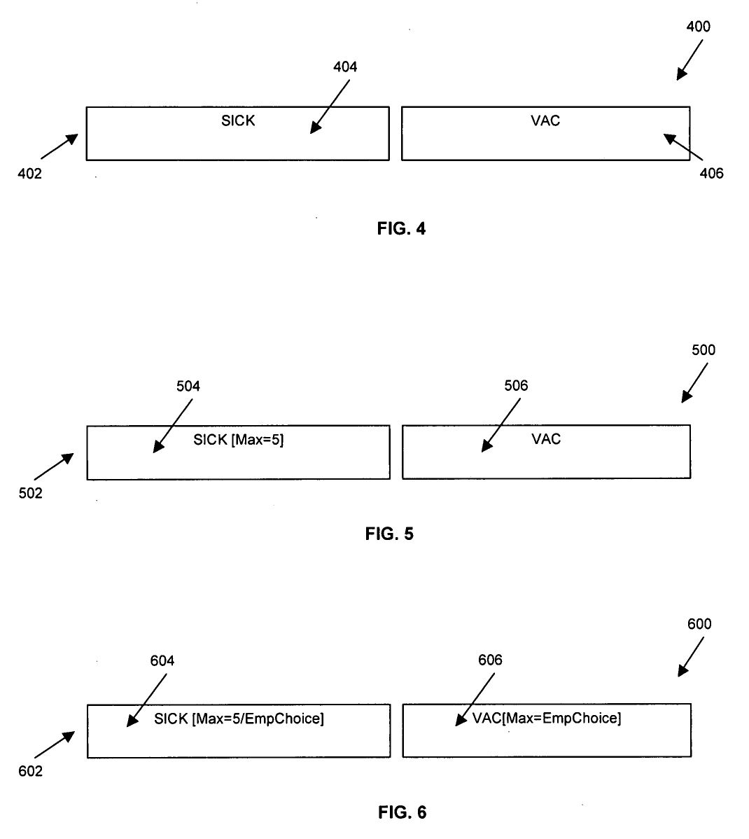

Reference is now made to FIG. 4, which illustrates leave policy 400. Leave policy 400 comprises a single sequence 402, which in turn comprises two segments 404 and 406. Segment 404 corresponds to sick leave and segment 406 corresponds to vacation leave.

Leave policy 400 is an example of a leave policy that may be applied by leave policy manager system 10 to an absence of an employee that does not qualify for long-term leaves such as those under the FMLA. Under policy 400, sick leave will run until the sick leave balance is exhausted. At which point, the vacation leave will run until the vacation leave balance is exhausted. After the vacation leave balance is exhausted, the absence becomes bare.

As can be seen from FIG. 4, there is an implied dependency relationship between segments 404 and 406. This means that the vacation leave segment 406 will not run until the sick leave segment 404 is completed. In LPNL, leave policy 400 may be described as:

1: SICK, VAC

Reference is now made to FIG. 5, which is a schematic diagram that illustrates leave policy 500. Leave policy 500 comprises a single sequence 502, which in turn comprises two segments 504 and 506. Segment 504 corresponds to sick leave and segment 506 corresponds to vacation leave. Thus, leave policy 500 is similar to leave policy 400 of FIG. 4, except that unlike sick leave segment 404, sick leave segment 504 has an attribute that indicates a maximum. The maximum restricts the amount of balance of that leave that the sick leave segment 504 can consume. In the case of policy 500, the maximum is five days.

In some embodiments, the MAX attribute applied to a segment can be extended to also limit the total elapsed time available to the employee, in addition to limiting the balance. Thus, for example, if it were the case that an employee were absent for a half day each morning for three consecutive days, then specifying a MAX attribute of two days balance for an applicable leave segment would not have no consequence in this scenario. In contrast, specifying a MAX attribute of two elapsed days would prevent the leave segment from being applied on the third day. If there is no other valid leave, then this may lead to a bare absence.

Thus, leave policy 500 may be applied by leave policy manager system 10 to an absence of an employee that does not qualify for long-term leaves such as those under the FMLA. Policy 500 includes a maximum for sick leave segment 504 that may have been input by an authorized user in response to a corporate policy.

Under leave policy 500, sick leave will run until one of two events occurs: either the sick leave balance runs out or the maximum of 5 days is reached. After either of these two events occurs, the vacation leave runs until the vacation leave balance is exhausted or the absence ends. After the vacation leave balance is exhausted, the absence becomes bare. In LPNL, leave policy 500 may be described as:

1: SICK [Max=5], VAC

Reference is now made to FIG. 6, which is a schematic diagram that illustrates leave policy 600. Leave policy 600 comprises a single sequence 602, which in turn comprises two segments 604 and 606. Segment 604 corresponds to sick leave and segment 606 corresponds to vacation leave. Leave policy 600 is similar to leave policy 500 except that each of the segments of leave policy 600 includes an employee choice for an amount to be taken. In various embodiments, the employee choice may not exceed the maximum. In various other embodiments, the employee may enter any value they desire but leave policy manager system 10 will effectively ignore any values above the maximum. In addition, in some embodiments, the choice is optional and the employee is not required to make a choice. In addition, in various embodiments, the employee may make a choice with respect to one segment and not with respect to others. In some embodiments, if the employee does not make a choice then leave policy manager system 10 treats the policy as if no choice was available. Thus, in a situation in which the employee has made no choice, leave policy manager system 10 would treat policy 600 the same as policy 500.

Leave policy 600 may be applied by leave policy manager system 10 to an absence of an employee that does not qualify for long-term leaves such as those under the FMLA. Sick leave segment 604 has two attributes: a maximum and an employee choice. The maximum is set to five days. In some embodiments, the employee would be able to choose any value of 5 days or less as their choice. As explained above, in various other embodiments, the employee may enter any value they desire but leave policy manager system 10 will effectively ignore any values above the 5 day maximum. The vacation segment 606 has one attribute—employee choice and this attribute may be set to any value.

In various embodiments, under leave policy 600 sick leave will run until the first of three events occur: (1) the sick leave balance runs out, (2) the employee choice is reached, or (3) the maximum of 5 days is reached. After any of these events occur, the vacation leave begins to run. Of course, if the absence ends before either of those three events, then sick leave will stop running and the vacation leave will not begin to run. Thus, through the use of this choice the employee can cause leave policy manager system 10 to apply between 0 and 5 days to the employee's absence, provided that the sick leave balance is sufficient for the choice. The vacation leave runs until the first of two events occurs: (1) the vacation leave balance is exhausted or (2) the employee choice is reached. In addition, if the absence ends then vacation leave will also stop running. After the vacation leave balance is exhausted, the absence becomes bare. In LPNL, leave policy 600 may be described as:

1: SICK [Max=5/EmpChoice], VAC[Max=EmpChoice]

In various embodiments, leave policy manager system 10 may allow employees to change the order of discretionary leave segments in a particular segment. Thus for example, with respect to leave policy 600, leave policy manager system 10 may allow an employee to switch the order of segments 604 and 606.

In addition, leave policy manager system 10 may allow the employer to make various changes to the policies. Thus, the maximums could be entered for individual segments. For example, the following leave policy could be used:

1: SICK [Max=5/EmpChoice], VAC[Max=10/EmpChoice]

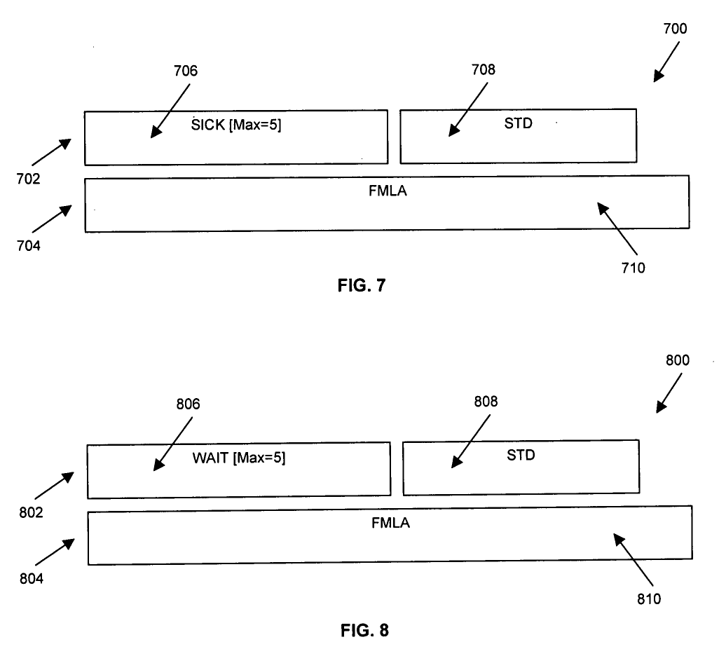

Reference is now made to FIG. 7, which is a schematic diagram that illustrates leave policy 700. Leave policy 700 comprises two sequences 702 and 704. Sequence 702 comprises two segments: sick leave segment 706 and short term disability (STD) leave segment 708. Sequence 704 comprises a single FMLA leave segment 710.

Leave policy 700 is an exemplary policy that the leave policy manager system 10 may apply to an absence that an employee takes under the FMLA. As required by statute, the FMLA leave begins to run on the first day of the reported absence and runs concurrently with other types of leaves. For this reason, the FMLA leave is in its own sequence 704.

In addition, according to the FMLA statute, the employer may require that the employee use his or her discretionary leaves. Accordingly, in some embodiments, leave policy manager system 10 allows an employer to set up a leave policy that requires an employee to use a discretionary leave if the employee has a balance for that discretionary leave. Thus, leave policy 700 is an example of a leave policy in which the employee is required to take up to 5 days of his or her remaining sick leave days. For this reason, segment 702 begins with the sick leave segment 706, which has a maximum value of 5 days. After either (1) the sick leave balance is depleted, or (2) the maximum of 5 days is reached, the STD leave segment 708 begins to run. From that point on, the STD leave segment 708 will continue to run until it is depleted. If the absence ends, then any leaves that are running will stop running.

In FIG. 7, sequence 702 has been deliberately illustrated as being shorter that sequence 704 in order to indicate that leave policy manager system 10 allows for the fact that the various sequences can end at different times. Although sequence 702 has been illustrated as ending before sequence 704, the opposite situation is also possible, where sequence 704 ends before sequence 702.

If either sequence ends before the other, then the sequence which is still running prevents a bare absence from occurring. A bare absence will only occur when all the sequences have run out. However, it may be the case that one situation is more favorable for the employee than the other. For example, if sequence 702 terminates before sequence 704 then the employee will likely be protected from discipline but will not be paid. In the reverse situation the employee may be paid but may not be provided with the same level of protection from discipline.

Using LPNL, leave policy 700 may be represented as:

1: SICK[Max=5], STD

2: FMLA

Reference is now made to FIG. 8, which is a schematic diagram of leave policy 800. Leave policy 800 comprises two sequences 802 and 804. Sequence 802 comprises two segments: wait segment 806 and STD leave segment 808. Sequence 804 comprises a single FMLA leave segment 810. Wait segment 806 does not correspond to any type of leave. Rather, its purpose is to delay the start of a segment before which it appears by a set amount. In the case of leave policy 800 the length of the delay is 5 days. However, this is a parameter that may be altered by an authorized user 36. In some embodiments, a wait period may be set according to corporate policy or an insurance policy in force around STD.

Leave policy 800 is an example of a policy that may be applied by leave policy manager system 10 to an absence of an employee, which is taken under the FMLA. However, unlike in policy 700, in policy 800 there is no option for an employee to take sick leave. Under leave policy 800, the employee is required to wait for 5 days before he or she is eligible for STD. Thus, the employee will not be paid until after the 5 day wait period has expired. However, during that time, the absence will not be considered bare because the FMLA leave segment will be running and thereby protect the employee from being disciplined. In LPNL, leave policy 800 may be represented as:

1: WAIT[Max=5], STD

2: FMLA

In various embodiments of leave policy manager system 10, it may also be possible to implement dependencies between segments in different sequences of a given policy. Leave policy manager system 10 may accomplish this by including an attribute in a segment of a policy. Such an attribute can specify a characteristic of the segment in which it appears in relation to one or more characteristics of one or more segments. Such attributes may be used for, but are not limited to, specifying a start or end time of one segment in relation to a start or end time of one or more segments.

Two examples of such attributes, which are not intended to be limiting, include the “WaitForFinish” and “DoUntilStart” attributes. The “WaitForFinish” attribute is used by leave policy manager system 10 to delay the start of a particular segment or sequence until one or more other segments have finished. Since according to various embodiments of leave policy manager system 10, segments within a sequence are executed in the order in which they appear, the WaitForFinish attribute can be used to delay not only the segment in which it appears but all other segments that follow in the same sequence.

The “DoUntilStart” attribute is used by leave policy manager system 10 to stop a particular leave segment from running once one or more leave segments have started. In various embodiments, leave policy manager system 10 will cause a segment to be skipped if it contains a “DoUntilStart” condition that is already true.

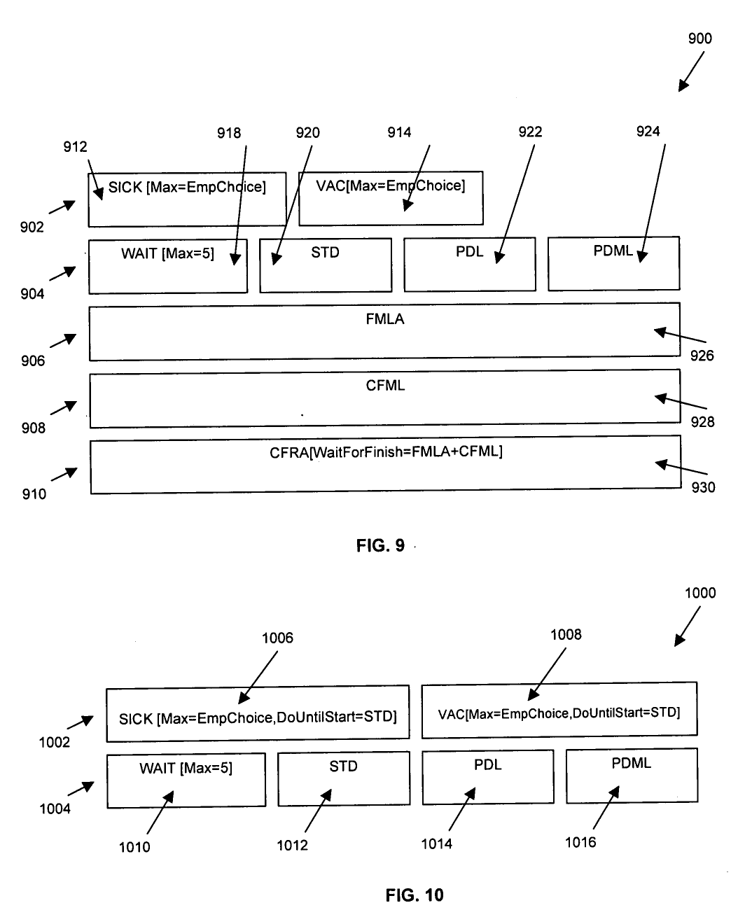

Reference is now made to FIG. 9, which illustrates an exemplary leave policy 900 that makes use of the WaitForFinish attribute. Leave policy 900 is an example of a policy that may be used by leave policy manager system 10 to track an absence of an employee that is taken under a California pregnancy disability leave. Leave policy 900 comprises 5 sequences: 902, 904, 906, 908, and 910. Sequence 902 comprises sick leave segment 912 and vacation leave segment 914. Sequence 902 operates in a similar manner to above-described sequence 602 of leave policy 600 of FIG. 6 and will therefore not be described in further detail. Sequence 904 comprises 4 segments: the wait segment 918, STD segment 920, Pregnancy Disability Leave (PDL) segment 922, Post Disability Maternity Leave (PDML) segment 924. The wait segment has already been described. Each of the following segments in sequence 904 run in succession until the associated balances are depleted, or other conditions occur to stop the segments from running.

Sequences 906 and 908 each have only one segment, FMLA segment 926 and California Family Medical Leave, also know as California FML, (CFML) segment 928 respectively. All sequences 902, 904, 906, 908, and 910 run concurrently with each other.

Sequence 910 comprises a single California Family Rights Act (CFRA) segment 930 that contains a WaitForFinish attribute. In the case of CFRA segment 930 the WaitForFinish attribute specifies that CFRA segment 930 will not start until both the FMLA and CFML segments have finished (i.e. until the last of the two finishes). In various embodiments, it may be possible to specify that a segment containing the WaitForFinish attribute does not start until some combination of the listed segments have finished. For example, it may be possible to specify that CFRA segment 930 does not start until either FMLA segment 926 or CFML segment 928 finishes, which ever comes first.

In LPNL, policy 900 may be expressed as:

1: Sick[Max=EmpChoice], VAC[Max=EmpChoice]

2: Wait[Max=5], STD, PDL, PDML

3: FMLA

4: CFML

5: CFRA[WaitForFinish=FMLA+CFML]

Reference is now made to FIG. 10, which illustrates an exemplary leave policy 1000 that makes use of the “DoUntilStart” attribute. Leave policy 1000 is an example of a policy that may be used by leave policy manager system 10 to provide paid discretionary leave to an employee only up until the short term disability leave begins. Leave policy 1000 comprises sequence 1002 and sequence 1004. Sequence 1002 comprises sick leave segment 1006 and vacation leave segment 1008. Sequence 1004 comprises wait segment 1010, STD segment 1012, PDL segment 1014, and PDML segment 1016. Sequence 1004 is similar to sequence 904 of leave policy 900 of FIG. 9 and will therefore not be described in detail.

Sick leave segment 1006 and vacation leave segment 1008 each contain the “DoUntilStart” attribute. As described above, this attribute prevents the segment that contains it from continuing to run after the segment specified by the attribute has started. In the case of policy 1000 sick leave segment 1006 will run until the first of three conditions becomes true: (1) the amount set by the employee is reached, (2) the STD segment 1012 begins to run, or (3) the sick leave balance is depleted. If sick leave segment 1006 stops running before STD segment 1012 begins to run, then vacation leave segment 1014 will start to run. Vacation leave segment 1008 will run until the first of three conditions becomes true: (1) the amount set by the employee is reached, (2) the STD segment 1012 begins to run, or (3) the vacation leave balance is depleted. Of course, if the absence ends, then any currently running leave will stop running.

In LPNL, leave policy 1000 may be expressed as:

1: Sick[Max=EmpChoice,DoUntilStart=STD],

VAC[Max=EmpChoice, DoUntil Start=STD]

2: Wait[Max=5], STD, PDL, PDML

In various embodiments, a particular leave may occur in more than one sequence. In this case the segment identifiers in the WaitForFinish or DoUntilStart attributes will contain additional information to further identify the specific segment for which the condition applies.

In various embodiments, user 36 can utilize LPNL to create or alter leave policies. For example, user 36 can enter new leave policies through user workstation 28. In other embodiments, a graphical interface may be used such that user 36 can use user workstation 28 to drag and drop segments into sequences and thereby arrange leave policies. The user 36 may then enter values for conditions. In this manner, a user 36 may create new leave policies, alter old leave policies, or customize leave policies for particular employees.

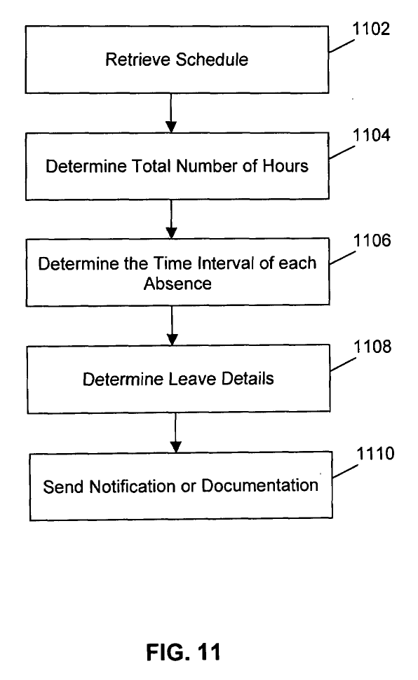

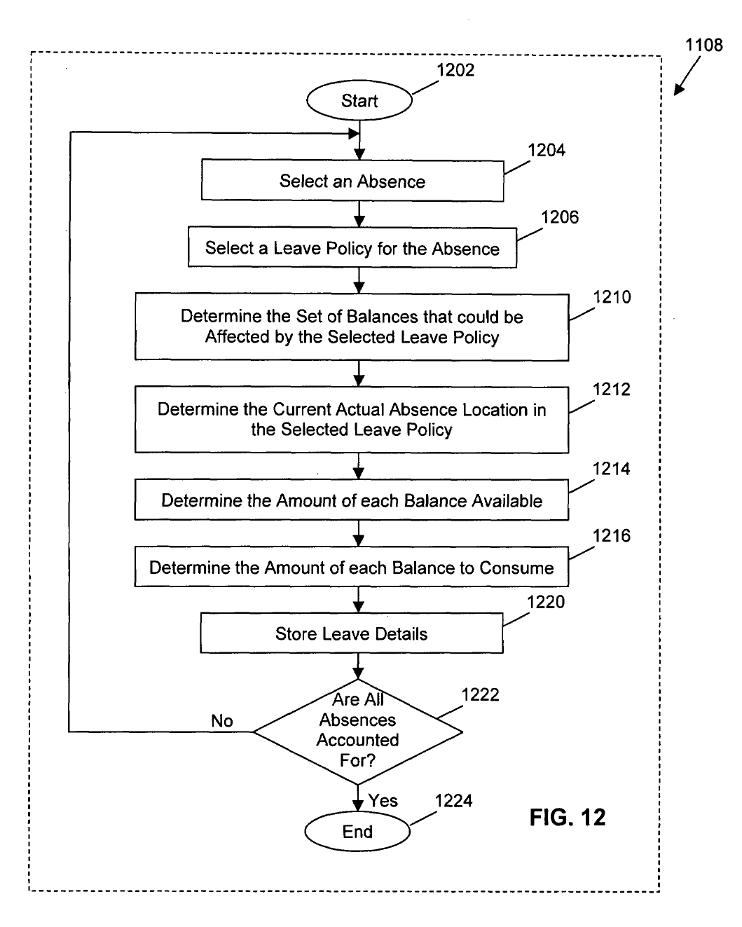

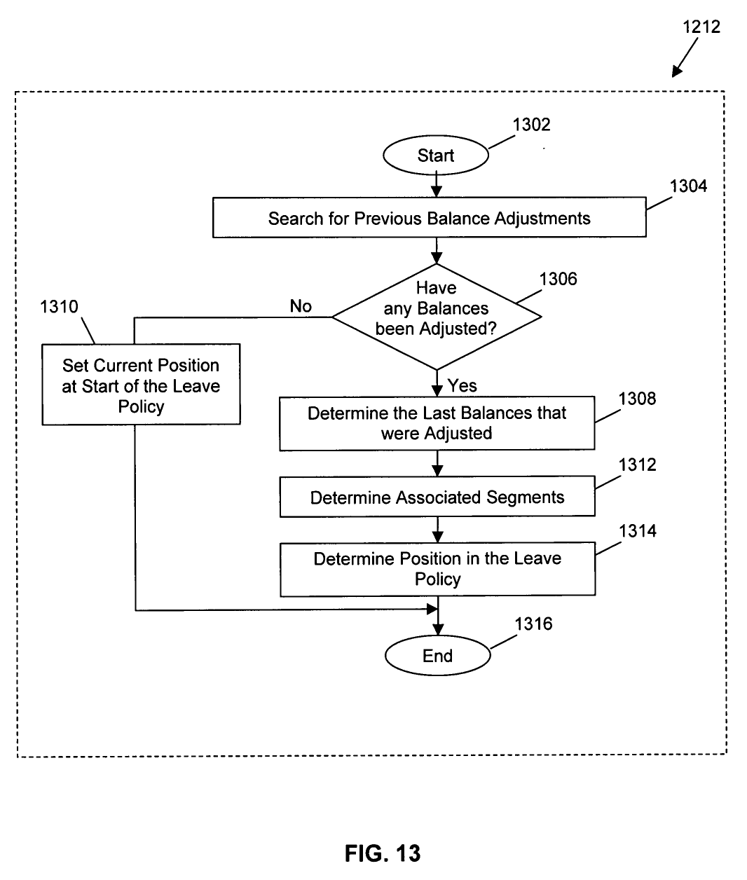

Reference is now made to FIG. 11, which is a flowchart that illustrates the basic steps taken by leave policy manager system 10. At step 1102, the employee schedule is retrieved. At step 1104, the total number of hours that the employee was scheduled to work over the time period is determined. The time period may be measured in any appropriate units including, but not limited to hours, days, weeks, months or years. In some embodiments, the time period is a single unit of time, such as a day or a week.

At step 1106, each absence within the time period is identified. This step involves determining the actual time intervals during the day that the employee was absent and identifying the reasons for the absence. The actual absence may differ from the absence originally reported by the employee. At step 1108, the leave details are determined for each absence identified at step 1106. At step 1110, any notification and documentations requirements are identified and provided.

Reference is now made to FIG. 12, which illustrates the steps taken by leave policy manager system 10 when determining leave details according to various embodiments. In some embodiments, the absences may be processed at the end of a predetermined period. Thus, in some embodiments, this may be done at the end of each day. However, this is meant to be exemplary only. No specific time period needs to be used. For example, an employee's entire time away from work may be processed after the employee's return.

The method begins at step 1202. At step 1204, an actual absence is selected. The absence may be selected in any appropriate manner. For example, the absences may be selected according their chronological order.

At step 1206, an appropriate policy for the absence is selected. At step 1210, the set of balances that can be affected by the selected leave policy is identified. At step 1212, the location in the selected leave policy is identified.

At step 1214, the amount of balance available for each leave in the leave policy is determined. This step involves removing any balance that was consumed by previous absences and adding any entitlements that may have occurred on that day.

At step 1216, the leave policy manager system 10 determines the amount of each balance associated with a leave in the selected leave policy that should be consumed as a result of the absence.

At step 1220, the leave details that have been calculated for the current absence are stored. At this step, information including, but not limited to, the balances consumed and whether or not the absence is bare may be stored. For example, if each sequence in the leave policy has not been able to cover the absence, then the absence will be bare. After step 1220 is complete, step 1222 is executed.

At step 1222, it is determined whether all of the absences for the time period have been processed. If yes, then the process ends at step 1224. If all of the absences have not been processed, then the method returns to step 1204.

Reference is now made to FIG. 13, which is a flowchart that illustrates the steps taken by leave policy manager system 10 when determining the current position in a leave policy.

The process begins at step 1302. At step 1304, leave policy manager system 10 searches for previous balance adjustments. At step 1306, leave policy manager system 10 determines whether there were any previous balance adjustments. If there have been any previous balance adjustments then the method moves to step 1308. On the other hand, if no previous balance adjustment has occurred, then the method moves to step 1310.

At step 1308, leave policy manager system determines the last balances to have been adjusted. At step 1312, leave policy manager system 10 identifies the segments associated with the balances that were identified in step 1308. At step 1314, a position in the leave policy is identified based on the segments identified at step 1312. After step 1314 is completed, the process ends at step 1316.

In contrast, if no previous balance adjustment has occurred then at step 1310, leave policy manager system 10 sets the beginning of the sequence to be the starting point. After step 1310 is completed, the process ends at step 1316.

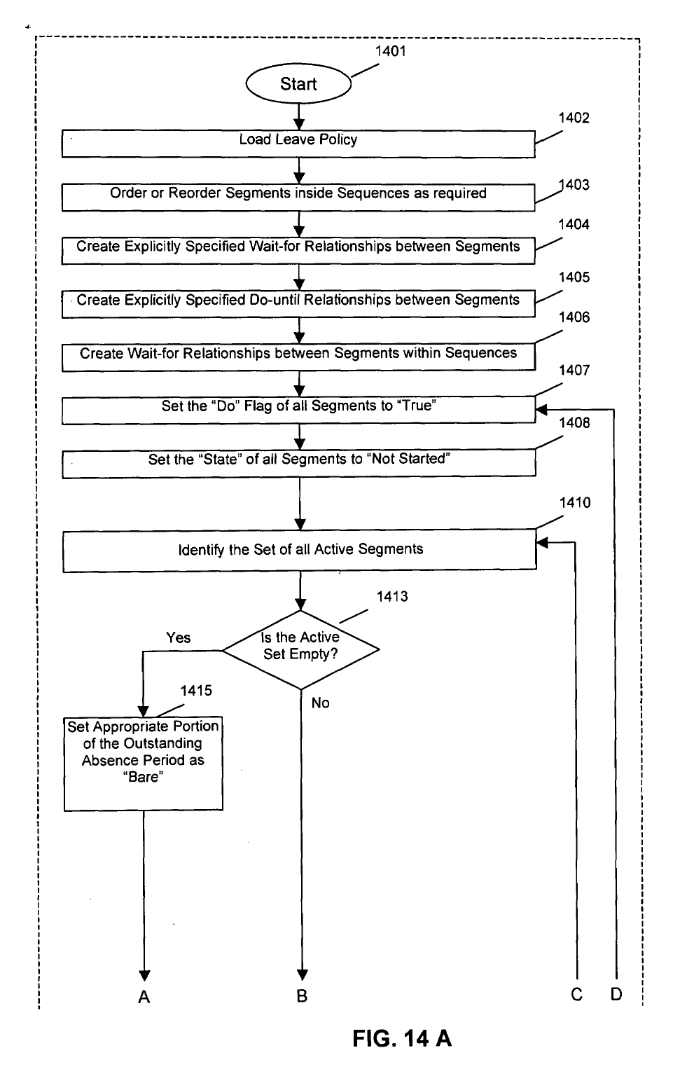

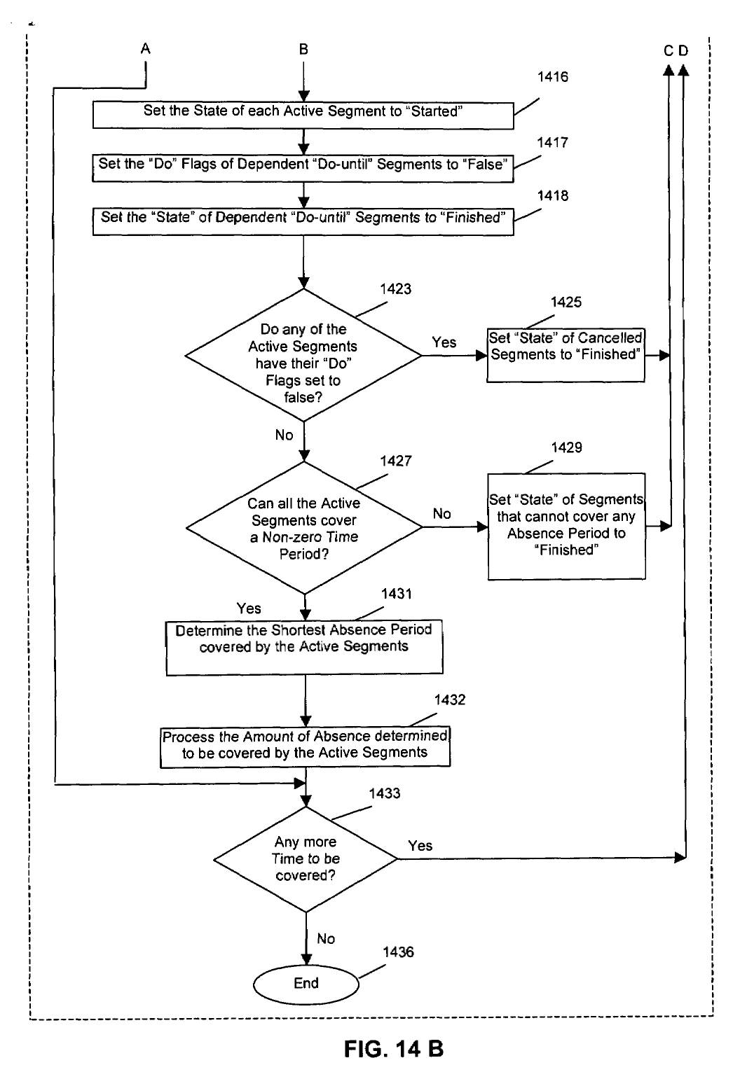

Reference is now made to FIGS. 14A and 14B, which are flowcharts of the steps taken by leave policy manager system 10 when determining the amount of balance to consume. The method begins at step 1401.

At step 1402, the leave policy is loaded. At step 1403, an order of segments is selected for reorderable sequences. In some sequences, which may be referred to as reorderable sequences, the specific ordering of segments is flexible. Thus, at this step, an ordering for segments is selected. This may be done in any appropriate manner. For example, in some embodiments, an appropriate user 36 may select an ordering.

At step 1404, WaitForFinish relationships are created between segments according to the relationships specified by the leave policy.

At step 1405, DoUntilStart relationships are created between segments according to the relationships specified by the leave policy.

At step 1406, WaitForFinish relationships that are implied by the sequences are created. For example, when one segment follows another in a sequence, this may generally be represented by a WaitForFinish relationship in which the segment that follows waits for the preceding segment to finish before starting.

In various embodiments, other dependencies other than WaitForFinish and DoUntilStart may be utilized and created at steps 1404, 1405 and 1406. In some embodiments, these steps may be implemented by creating a leave policy graph.

After steps 1404, 1405 and 1406 have been processed, it is no longer helpful to refer to sequences given that all the information provided by the use of the concept of a sequence has been translated into WaitForFinish relationships.

At step 1407 a “do” flag, which is a property associated with a particular segment, is created for each segment. The “do” flag is used to track the status of each segment with respect to any DoUntilStart relationships it may have. In various embodiments, the “do” flag could be represented by a binary value. The “do” flag of each segment is set to the initial value of “true”, which indicates that the corresponding segment does not have a DoUntilStart dependency on a segment that has started to run or has been considered to run in this iteration. Accordingly, a “false” value indicates that the corresponding segment does have a DoUntilStart dependency on a segment that has started to run or has been considered to run in this iteration.

The “do” flag may be implemented in any appropriate manner. For example, in some embodiments, a memory representation of a segment may include this data; while, in other embodiments it may be separated from the segment definition. Furthermore, the actual data type and values used to represent the “do” flag can be selected in any appropriate manner.

At step 1408 a segment “state”, which is a property associated with a particular segment, is created for each segment. The segment “state” is used to track whether the associated segment is currently running. In some embodiments, the segment “state” may take on three values: “not started”, “started”, and “finished”. The segment “state” is set to the initial value of “not started”.

The segment “state” may be implemented in any appropriate manner. For example, in some embodiments, a memory representation of a segment can include this data; while, in other embodiments it may be separated from the segment definition. Furthermore, the actual data type and values used to represent the “state” information can be selected in any appropriate manner.

At step 1410, leave policy manager system 10 identifies the set of all active segments to be considered. This is accomplished by identifying all segments that have a segment “state” value other than “finished” and that do not have any incoming wait-for relationships from other segments that have a segment “state” value other than “finished”. Thus, this set is comprised of the segments that are ready to be consumed and are not currently waiting for any conditions to be true before beginning. In other words, if any segment in this set is dependent on a condition, that condition is currently true.

At step 1413 it is determined whether the set identified at step 1410 is empty or not. If the set is empty that means that no segment is currently available for use and that the following period of absence is ‘bare’. If the set is determined to be empty, then step 1415 is executed. Conversely, if at step 1413 it is determined that the set identified at step 1410 is not empty, then step 1416 is executed.

At step 1415, leave policy manager system 10 declares an amount of the remaining absence to be “bare”. The amount of absence to be declared as bare is determined, in part, by establishing the time at which the first situation-changing event occurs. A situation-changing event may be for example, but is not limited to, an event that changes the status of the absence, a leave, or eligibility of an employee. Further examples of situation changing events are discussed below. Thus, the period of absence that is declared to be “bare” is the period that begins at the last point in time for which the absence was processed (or if the absence has just begun then at the start of the absence) and ends at the point in time at which the first situation changing event (that occurs after the start of the period) occurs.

Consider the following examples, which will be used to illustrate events that may be referred to as situation-changing events: an employee accrues balance for a leave, such as vacation, in the middle of an absence; the absence was approved manually by an authorized person. In the above example, if the absence ends, then this could be a situation-changing event. Another situation-changing event may occur as a result of additional balance that was added to the vacation leave. Specifically, the vacation leave may have been exhausted, thereby preventing the vacation leave from running, and there may have been no other valid leave. With the additional balance, the vacation leave may begin to run and the absence may no longer be bare. Another situation-changing event may occur if the absence crossed a time boundary in which it no longer violated a leave pattern, when it previously did. Similarly, if the absence crossed a time boundary in which it now violates a leave pattern, when it previously did not, then this may also constitute a situation-changing event. It should be understood that while several examples of situation-changing events have been described, the above description is exemplary only and that situation-changing events are not limited to the events specifically described in the above examples.

At step 1416 leave policy manager system 10 starts all active segments identified at step 1410 by setting their segment “state” to “started”.

At step 1417, leave policy manager system 10 cancels all segments with “do-until” relationships that are dependant on the segments being started by setting the “do” flag of those dependent segments to “false”.

At step 1418, leave policy manager system 10 sets the segment “state” of all segments with “do-until” relationships that are dependent on the segments being started to “finished”.

At step 1423 leave policy manager system 10 determines whether any one of the segments that was cancelled at step 1417 was in the active set (identified at step 1410). This is accomplished by checking the “do” flags of the active segments. A “do” flag value of “false” indicates that the corresponding segment has been cancelled. If any segments from the active set have been cancelled, then step 1425 is executed. If no segments have been cancelled, then step 1427 is executed.

At step 1425, the segment “states” of all the cancelled segments (i.e. those segments that have their “do” flags set to “false”) are set to “finished”. After step 1425 is processed, step 1410 is repeated.

It should be understood, that various embodiments might not repeat step 1410 after executing step 1425. The various embodiments of leave policy manager system 10 that execute the method illustrated in FIGS. 14A and 14B, repeat step 1410 after executing step 1425 in order to update the active set. However, various other embodiments do not update the active set in this manner. In particular, they do not completely re-identify all segments in the active set. In stead, these embodiments incrementally change the active set by removing or adding any segments as needed.

At step 1427 leave policy manager system 10 determines whether all the currently active segments (as identified at step 1410) may be utilized together to cover a non-zero duration of absence. This may be accomplished by validating that every active segment can be consumed for an actual non-zero period of time. This check may include, but is not limited to, balance, leave pattern, and approval status checks. If at least one segment fails to allow consumption of a non-zero time period, then step 1429 is executed. On the other hand, if all active segments allow consumption of some non-zero time period, leave policy manager system 10 proceeds to step 1431.

At step 1429, the segment “state” of each segment, which at step 1427 was found not to be able to cover any absence period, is changed to “finished”. For example, in some embodiments, some absences may be measured in minutes and at step 1429, any segment that cannot cover more than 0 minutes would have its state set to “finished”. After step 1429 is processed, step 1410 is repeated.

It should be understood, that various embodiments might not repeat step 1410 after executing step 1429. The various embodiments of leave policy manager system 10 that execute the method illustrated in FIGS. 14A and 14B, repeat step 1410 after executing step 1429 in order to update the active set. However, various other embodiments do not update the active set in this manner. In particular, they do not completely re-identify all segments in the active set. In stead, these embodiments incrementally change the active set by removing or adding any segments as needed.

At step 1431 leave policy manager system 10 determines the appropriate amount of time for processing the absence. The appropriate amount of time for processing the absence maybe determined as the minimum of (1) the remaining absence duration and (2) the minimum time of all the maximum times available for consumption by any and all active segments. In other words, if each segment can cover a time period that is greater than the remaining absence period, then the appropriate amount of time for processing the absence is the length of the remaining absence. On the other hand, if at least one segment can only cover a time period that is less than the remaining absence duration, then the appropriate amount of time for processing the absence is the minimum amount of time that can be covered by all of the active segments. In the latter case, the minimum time that can be covered by the segments may be determined by comparing the amount of time covered by each segment and selecting the minimum.

In various embodiments, the absence may be processed for regular time periods. For example, absences may be processed for individual days. In such embodiments, the term “remaining absence duration” may refer to the amount of absence that remains in the current period being processed even if it is known that the absence will continue past the current time period. In other embodiments, some absences may be processed all at once and therefore such considerations do not apply.

At step 1432, leave policy manager system 10 processes the next remaining amount of absence, which has a duration equal to the time period determined at step 1431, by applying all leaves pertaining to active segments. This includes, but is not limited to, calculating and making balance adjustments, and recording any violations.

At step 1433, it is determined whether there is any outstanding actual absence, which is related to the current leave policy that was loaded at step 1402, to be covered. In other words, this step determines whether there is any remaining absence to be addressed after any amount of absence may have already been addressed by step 1432 and/or step 1415. If there is any remaining absence to be addressed, then step 1407 is repeated. Thus, the remaining absence is processed in the same manner as was described above. This is continued until the entire actual absence period is addressed (by either steps 1432 or 1415).

If it is determined at step 1433 that there is no remaining absence to be addressed, then the method ends at step 1436. At this point, the entire contiguous actual absence has been processed, possibly through more than one chunk separately processed in step 1431 and/or step 1415. However, there may be more actual absences following the first absence. They could apply to a different absence and/or different leave policy, etc. As such they are addressed by either repeating the entire method or, in some embodiments, by starting from step 1408 if the previously loaded leave policy can be reused.

In various embodiments, an authorized user 36 may enter appropriate commands through user work station 28 and thereby force a leave segment, which would otherwise be inactive, to be treated as an active segment. This may, for example, be done for compassionate reasons or any other appropriate reason. As a result of entering such a command, the leave policy manager system 10, processes the leave despite the fact that it is otherwise inactive.

For example, the leave segment may not have any remaining balance and would otherwise be treated as inactive; however, if the appropriate commands were entered, leave policy manager system 10 would treat the leave segment as active but would not remove any balance. More specifically, referring to FIGS. 14A and 14B, the leave segment would be treated as active for purposes of steps 1414 and 1430. In addition, for the purpose of step 1438 the segment may be treated as having an additional amount of balance. However, at step 1446 once the associated balance has run out, leave policy manager system 10 would continue to process the segment as if there were balance available but would not attempt to remove any more balance.

In some embodiments, user 36 can specify a specific time frame in which the forced treatment of the segment is applied. In addition, in various embodiments, all other characteristics of the leave, such as, but not limited to, its paid and discipline status, remain the same. In various, other embodiments, an authorized user 36 may enter appropriate commands to modify such characteristics.

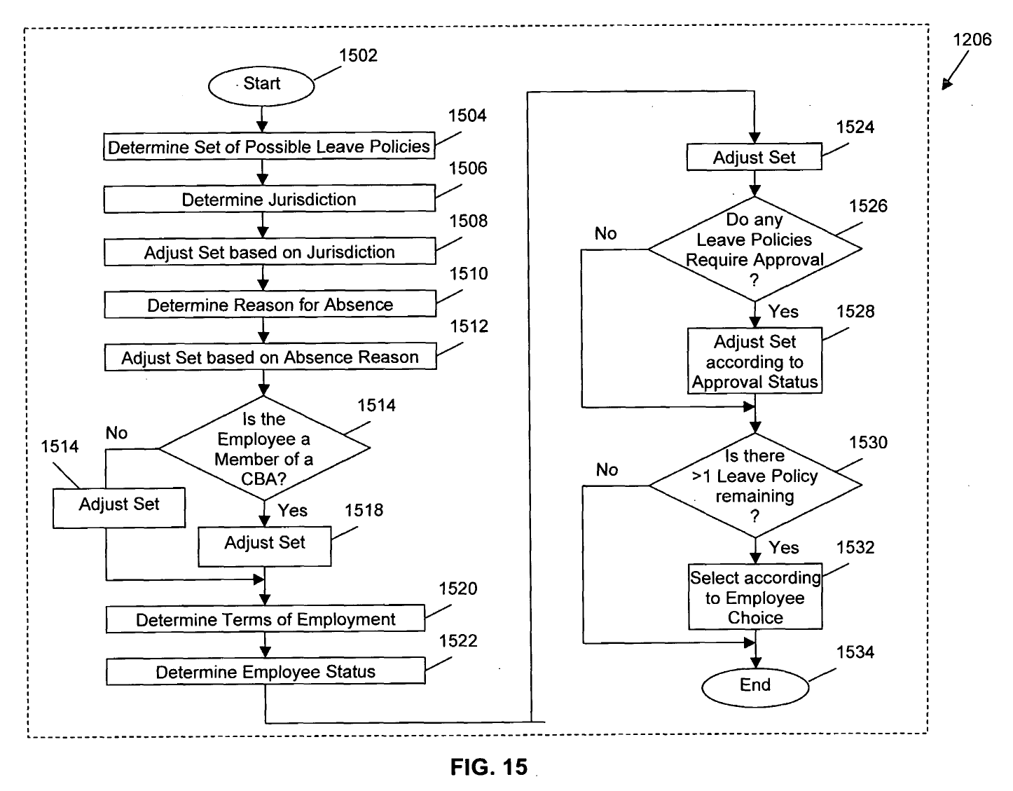

Reference is now made to FIG. 15, which is a flowchart illustrating an exemplary set of operational steps by which leave policy manager system 10 determines an appropriate leave policy to apply.

The process begins at step 1502. At step 1504, the set of possible leave policies for the employee is determined. In some embodiments, this information may already be available. For example, all leave policies that may apply to a specific employee may have already been determined and stored within the employee database 22.

At step 1506, the relevant jurisdiction is determined. At step 1508, the set of possible applicable leave policies is adjusted based on the jurisdiction. It should be understood that in various embodiments, steps 1506 and 1508 need not be explicitly implemented. In particular, in some embodiments, a relevant employee may only operate in a single jurisdiction.

At step 1510, a reason for the absence is determined. This may be accomplished in any appropriate manner. For example, the reason may have been entered by any appropriate user 36 based on information provided by the employee, the employee's supervisor, any other appropriate individual or user 36. At step 1512, the set of possible leave policies is adjusted based on the reason for the absence.

At step 1514, leave policy manager system 10 determines whether or not the employee is a member of any collective bargaining agreements (CBA). If not, then step 1516 is executed. If so, then step 1518 is executed. At steps 1516 and 1518 the set of possible applicable leave policies is adjusted based on the employee's status with respect to any CBAs. After either step 1516 or 1518 is completed, step 1520 is executed.

At step 1520, any relevant terms of employment for the employee are determined. For example, the terms of employment may specify certain criteria that are required to be met in order to take certain leaves. For example, the employee may have to have worked a certain number of hours within a certain time period in order to take a certain leave. As another example, an employee may have had to be employed with the company for a certain amount of time before being able to take a certain leave or a certain amount of a particular leave. These criteria are meant to be exemplary only and other criteria may be specified.

In some embodiments, at step 1520, leave policy manager system 10 determines any relevant eligibility requirements specified by leaves contained in the set of leaves that may be applicable. For example, some leave policies may specify that an employee must have worked a certain number of hours in order to be eligible for the leave. A specific example of this is the FMLA, which requires that an employee have worked a minimum of 1250 hours before he/she is eligible. Alternatively, in some embodiments, this determination is made when deciding whether a segment is active, such as at step 1414 of FIG. 14A.

At step 1522, the employee's status with respect to the employment criteria or leave eligibility criteria determined at step 1520 is determined. For example, it may be determined whether or not the employee has worked the requisite number of hours within a time period specified by the terms of employment that would allow him or her to take a specific leave. At step 1524, the set of possible applicable leave policies is adjusted based on the terms of employment and the employee's status with respect to the terms.

It should be noted that in various embodiments, steps 1520 to 1524 are not executed when determining an appropriate leave policy. In some embodiments, certain terms may be used to select a leave policy while others may not be. For example, although the number of hours worked in a specific period of time has been described as being used to select a leave policy, in some embodiments it may not be used to select the leave policy. In such embodiments, such criteria may be used when determining whether a specific leave is to be applied. For example, it may be used at step 1414 of FIG. 14A to determine if a specific leave is active or not.

At step 1526, it is determined whether any of the remaining leaves in the set of possible applicable leave policies require approval. If yes, then step 1528 is executed. If not, then step 1528 is bypassed and step 1530 is executed. At step 1528, the set of possible applicable leave policies is adjusted based on the approval status. Thus, for example, any leave policies that have not been approved may be removed from the set. After step 1528 is complete, step 1530 is executed.

It should be noted that in some embodiments, steps 1526 and 1528 may not be executed. In such embodiments, it may be the case that individual leaves may require approval and not the leaves policies. Thus in such embodiments, the approval status may be checked when the specific leaves are to be applied. In particular, it may be used as a factor in determining whether a specific leave is active or not, such as for example at step 1414 of FIG. 14A.

At step 1530, it is determined whether more than one leave policy remains in the set of possible applicable leave policies. If not, then the process ends at step 1534. If yes, then step 1532 is executed. At step 1532, a leave policy is selected based on an employee choice. Alternatively, the choice may be made by any other appropriate criteria. After step 1532, the process ends at step 1534.

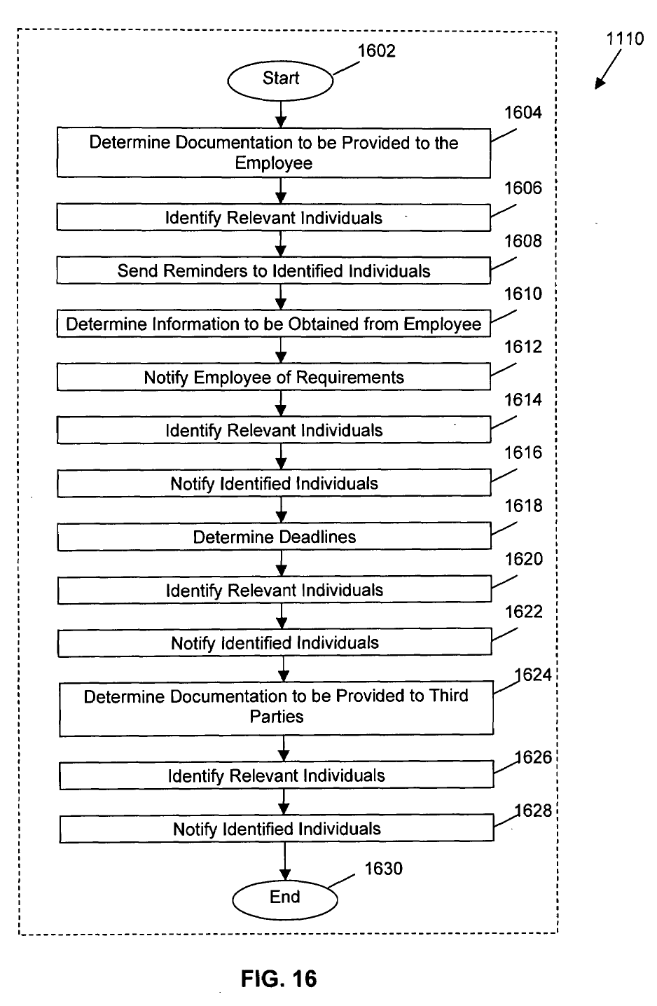

Reference is now made to FIG. 16, which is a flowchart illustrating an exemplary set of operational steps by which leave policy manager system 10 determines and sends appropriate notification and documentation based on the leaves that are applied. The process begins at step 1602.

At step 1604, leave policy manager system 10 determines any relevant documentation that needs to be provided to the employee. This decision may be made based on any applicable rules that may be by for example but not limited to, corporate policy, statutes or CBAs.

At step 1606, leave policy manager system 10 determines the relevant individuals that may generate and send the appropriate documents. At step 1608, leave policy manager system 10 sends appropriate notifications to the identified individuals in order to prompt them to generate and send the documentation. This may be done in any appropriate manner, such as by email, regular mail, fax, or automatic voicemails that may be sent to the individuals.

In addition, certain documents may be automatically generated and sent to the employee. In some embodiments, at step 1606 leave policy manager system 10 may determine that it or some other system may automatically generate such documentation. In such case, at step 1608, leave policy manager system 10 may itself cause such documentation to be generated or it may send appropriate instruction to another system to generate such documentation. Such documentation may comprise an email or an email attachment that may be sent by the appropriate system to the employee. Alternatively, the documentation may be printed by an appropriate system and then sent to the employee by appropriate staff, such as an individual working in the mailroom of the relevant company.

At step 1610, leave policy manager system 10 determines the documentation or information that is to be obtained from the employee. At step 1612, the employee is notified about any relevant documentation that is to be received. At step 1614, leave policy manager system 10 identifies relevant individuals that may be in charge of receiving such documentation from the employee. At step 1616, leave policy manager system 10 notifies the identified individuals that such documentation is to be expected. In some embodiments, the system may send reminders to such individuals so that they can follow up with the employee at appropriate times.

In addition, it may be the case that certain leaves may specify time limits within which an employee must provide certain documents. Thus, in various embodiments of leave policy manager system 10, if an employee does not provide the appropriate documentation within the specified time period, a leave may be denied automatically. This may be accomplished through requiring an appropriate user 36 to enter a command into user workstation 30 that acknowledges receipt of the documentation from the employee. If no such command is entered, then the leave may be automatically denied.

At step 1618, leave policy manager system 10 determines any deadlines that may have to be met by the employer. At step 1620, leave policy manager system 10 determines the appropriate actions to be taken before the deadline and the individuals within the company that may be responsible for taking these actions. At step 1622, the system notifies the appropriate individuals of the deadline and the action that is to be taken before the deadline. In some embodiments, leave policy manager system 10 may send reminders to the identified individuals at appropriate times.

At step 1624, leave policy manager system 10 determines any relevant documentation that needs to be provided to third parties, such as insurance providers or worker compensation providers.

At step 1626, leave policy manager system 10 identifies the relevant individuals that may generate and send the appropriate documents. At step 1628, leave policy manager system 10 sends appropriate notifications to the identified individuals in order to prompt them to generate and send the documentation. This may be accomplished in any appropriate manner, such as by email or automatic voicemails that may be sent to the individuals.

As described with respect to steps 1604 to 1608, certain documents may be automatically generated. In some embodiments, leave policy manager system may cause such documentation to be generated and sent in a manner analogous to that described with respect to steps 1604 to 1608.

After step 1628 has been executed, the process ends at step 1630.

While the above description provides examples of the embodiments, it will be appreciated that some features and/or functions of the described embodiments are susceptible to modification without departing from the spirit and principles of operation of the described embodiments. In particular, although some embodiments were described with respect to leave polices that may be applicable to certain jurisdictions, it is not intended to restrict the use of the invention to any particular state, province, country, territory, or any other legal jurisdiction. In addition, it is not intended to restrict the above embodiments to employees of any particular status including but not limited to unionized, non-unionized, full time, part time, casual, temporary, on contract. In addition, it is not intended to restrict the above embodiments to any particular type of employer, including but not limited to private corporations, sole proprietorships, partnerships, government corporations, or government departments. Accordingly, what has been described above has been intended to be illustrative of the invention and non-limiting and it will be understood by persons skilled in the art that other variants and modifications may be made without departing from the scope of the invention as defined in the claims appended hereto.

1. A method of administering leave policies to employee absences, the method comprising:
(a) determining at least one absence, having an absence length, for at least one employee in a time period;
(b) determining a leave policy for each absence, wherein the leave policy specifies at least one leave sequence having at least one leave, and wherein the leave has an associated leave balance;
(c) determining a position in each leave sequence; and,
(d) updating the at least one leave balance according to the position in the at least one leave sequence and the absence length.

2. The method of claim 1, wherein the time period is a day.

3. The method of claim 1, wherein
each sequence comprises at least one segment; and,
each leave corresponds to one segment.

4. The method of claim 3, further comprising identifying the segment corresponding to the position in the leave sequence.

5. The method of claim 4, wherein determining a position in the leave sequence comprises determining a position within the identified segment.

6. The method of claim 5, further comprising identifying a set of leave balances, wherein each segment within the at least one leave sequence has a corresponding leave balance within the set of leave balances.

7. The method of claim 6, further comprising determining whether at least one leave balance in the set of leave balances has changed value prior to the time period.

8. The method of claim 7, further comprising identifying a portion of leave balances in the set of leave balances that changed value as a result of a segment in the at least one leave sequence.

9. The method of claim 8, further comprising determining the position in the leave sequence by identifying the last leave balance to change value as a result of a segment in the leave sequence.

10. The method of claim 6, wherein each leave policy is further operable to specify leave constraints and a leave pattern.

11. The method of claim 10, wherein a leave pattern specifies a regularly repeating pattern of absences.

12. The method of claim 11, further comprising determining whether each segment is active based on the leave constraints and the associated leave balance.

13. The method of claim 12, wherein each leave balance corresponding to an active segment is updated based on the position, the leave constraints, and the absence length.

14. The method of claim 1, wherein step (b) comprises selecting a leave policy from a set of predetermined leave policies.

15. The method of claim 14, wherein at least one leave policy has a plurality of sequences.

16. The method of claim 15, wherein each sequence is applied concurrently to an absence.

17. The method of claim 16, wherein at least one sequence of at least one leave policy has a plurality of segments.

18. The method of claim 17, wherein each segment within a sequence is applied consecutively to an absence.

19. The method of claim 18, wherein each segment may specify at least one condition.

20. The method of claim 19, wherein the condition is chosen from the set of maximum, WaitForFinish, Employee Choice, and DoUntilStart.

21. The method of claim 20, further comprising creating a leave policy by selecting at least one segment from a set of segments and ordering the at least one segment into at least one sequence.

22. The method of claim 21, wherein at least one segment within the set of segments corresponds to one of the following: FMLA, State FML, Military Leave, Jury Duty Leave, Short Term Disability Leave, Long Term Disability Leave, Vacation leave, Sick Leave, Pregnancy Disability Leave, Education Leave, Bereavement Leave, Personal Day Leave, Sabbatical Leave, PDML, CFML, CFRA, and wait.

23. The method of claim 21, wherein at least one segment within the set of segments corresponds to a leave mandated by a statute.

24. The method of claim 23, wherein the statute is a federal statute.

25. The method of claim 23, wherein the statute is a state statute.

26. The method of claim 23, wherein the statute is a provincial statute.

27. The method of claim 23, wherein the statute is a territorial statue.

28. The method of claim 21, wherein at least one segment within the set of segments corresponds to a corporate leave.

29. The method of claim 21, wherein at least one segment within the set of segments corresponds to a wait segment.

30. The method of claim 23, further comprising specifying a value for each condition.

31. The method of claim 22, further comprising specifying a value for each wait segment.

32. The method of claim 1, wherein the time period is an hour.

33. The method of claim 1, wherein the time period is a minute.

34. The method of claim 1, wherein the time period is a week.

35. A system for administering leave policies to employee absences, the system comprising:
a memory for storing at least one leave policy, wherein the leave policy specifies at least one leave sequence having at least one leave, and wherein each leave has an associated leave balance;
the memory being further adapted to store the at least one associated leave balance;
a processor coupled to the memory, said processor configured for:
(I) determining at least one absence, having an absence length, for at least one employee in a time period;
(II) determining a leave policy for each absence;
(III) determining a position in each leave sequence; and,
(IV) updating the at least one associated leave balance according to the position in the at least one leave sequence and the absence length.

36. A computer-readable medium upon which a plurality of instructions are stored, the instructions for performing the steps of
(a) determining at least one absence, having an absence length, for at least one employee in a time period;
(b) determining a leave policy for each absence, wherein the leave policy specifies at least one leave sequence having at least one leave, and wherein the leave has an associated leave balance;
(c) determining a position in each leave sequence; and,
(d) updating the at least one leave balance according to the position in the at least one leave sequence and the absence length.
